(19) United States
(12) Patent Application Publication
(10) Pub. No.: US 2007/0288460 A1
(43) Pub. Date: Dec. 13, 2007

(54) Method of analyzing and searching personal connections and system for the same

(76) Inventors: Yaemi Teramoto, Tokyo (JP); Yasutsugu Morimoto, Kodaira (JP); Hiroyuki Kumai, Kunitachi (JP); Naoto Akira, Kokubunji (JP)

Correspondence Address: REED SMITH LLP, Suite 1400, 3110 Fairview Park Drive, Falls Church, VA, 22042, US

(21) Appl. No.: 11/730,691

(22) Filed: Apr. 3, 2007

(30) Foreign Application Priority Data
Apr. 6, 2006 (JP) 2006-104803

(51) Int. Cl. G06F 17/30

(52) U.S. Cl. 707/6; 707/E17.001

(57) ABSTRACT

A personal-connection analysis and search method includes the steps of extracting a word from a text used in communications, accumulating the number of times of appearing the word as a communication flow, generating communication networks in an organization, extracting communication cores having a high density communication from the communication networks, calculating a communication ratio as a communication core formal degree between two constituent members having a ladder-connection relationship with respect to total communications in the communication core, and calculating a ratio of formal communication flow as a communication formal degree between the two constituent members with respect to total communication flows between the two constituent members, thereby quantifying a index for judging whether communications in an organization of the enterprise are strongly relevant to a business operation.

### INCORPORATION BY REFERENCE

The present application claims priority from Japanese application JP2006-104803 filed on Apr. 6, 2006, the content of which is hereby incorporated by reference into this application.

### BACKGROUND OF THE INVENTION

The present invention relates to a personal analysis and search system, and particularly to a system and a method for generating personal-connection information by using electronic information communication data, calculating a index from personal-connections, and presenting the personal-connections.

According to the growth of computerized communication means such as an “electronic mail” and a “weblog”, these communication histories have been saved or accumulated with electronically formed conditions. A relationship between users as principals of the communications is extracted from the electronically formed communication logs, and the relationship is processed and re-used, which has been known as techniques for improving smoothness and liveliness of the communications.

In the invention disclosed in JP-A-10-301905 (Patent document 1), communications between information processing devices are set to as a pipe, and a relationship between persons is managed as a set of pipes each having a meaning and a weight representing connections. The document has also proposed a pipe expansion method for synthesizing plural pipe information to generate new pipes. Incidentally, the pipes are managed by respective information managing devices from the viewpoint of privacy protection.

A technique has also been known for searching persons matched with a search condition by using a relationship between persons and personal profiles. In the case of the invention disclosed in JP-A-2003-216799 (Patent document 2), business activity histories are registered in a storage unit, and a path is provided to be connected between an intellectual and a support-requested person in a company by a directly or indirectly acquainted person, in response to the business activities to be requested supports.

A method has been known for quantifying a relationship between persons and analyzing networks in communications among organized constituent members. In the invention disclosed in JP-A-2005-182439 (Patent document 3), a relationship between electronic mails is checked by only information of an addresser, an addressee and an originating time contained in the electronic mail to thereby investigate the communications in the organization.

A method of controlling communications has been known in response to a type of a relationship between persons. In the invention disclosed in JP-A-11-203322 (Patent document 4), personal-connection networks are divided into private and official relationships to implement a different processing given to one another. Incidentally, a relationship attribute is registered by user.

As a further relevant art, JP03446886 (Patent document 5) discloses a personal management system and personal search method in which communication histories for individuals and others are managed as personal-connection information to effectively use with the individual personal-connection information in common.

### PRIOR ARTS

Patent document 1: JP-A-10-301905

Patent document 2: JP-A-2003-216799

Patent document 3: JP-A-2005-182439

Patent document 4: JP-A-11-203322

Patent document 5: JP 03446886

non-patent document 1: “Basis of Social Network Analysis” by Jun Kanamitsu, Keisou Publishing Inc., Chart 6 “Centrality”, Dec. 20, 2003, vol. 1, Version 1

### SUMMARY OF THE INVENTION

In Patent documents 1, 2 and 5, there is no different position for users, but disclose the same position of communications.

In Patent documents 3 and 4, a processing is implemented on the basis of an organization and an official or private relationship, but members belonged to the organization and official or private relationship are set by user in advance.

Heretofore, it has been contemplated that communications within organizations, companies, etc. are unnecessary, except for formal (official) communications relative to organized operations. However, according to the progress of knowledge society in these years, the business operations carried through only by a top-down superintendent command have been decreased, particularly in the organizations such as modern enterprises. On the contrary, it has been important for informal activities such as autonomous decision making operations, information collection activities, and study meetings regardless of a ladder-connection in the organization, by company members as constituent members etc. In the meantime, the modern enterprise has maintained formal ladder-connections in the organization from the viewpoint of efficiency in the entire organization and carried through their business activities so that duties are divided into every ladder-connection and defined as they are.

In such case of the modern enterprises, they should be required for both the formal and informal activities, but their boundary between the activities are not only clearly divided, but also unclear so that one activity is high in a formal degree, and the other is low.

However, in the case where the constituent members in the organization take action for other party, particularly, for communications, it is difficult to judge such formal degree, approach by an appropriate way, and communicate directly to other parties.

It is therefore an object of the invention to provide a quantization of an index relative to formality for judging whether, of relationships between constituent members, a relationship is strongly relevant to a business operation or not in an organization having a formal structure with ladder-connections or the like, and also provide an organization display in accordance with a quantized formal degree and approach means for new other parties.

In order to achieve the objects, according to a personal-connection analysis and search system in the invention, a word is extracted from a text used in communications between constituent members in an organization, the number of times of appearing the word is accumulated as communication flows, and the communications in the organization are made into networks as a weight equivalent to the communication flows. The communication networks can be represented by a matrix or represented by (the number of constituent members)×(the number of constituent members), as communication flows are defined as values in the matrix. The communication flows are classified into every word or every concept which is categorized on the basis of the meaning of word, when the communication flows are accumulated. Further, when a user designates a word group or a natural text as a query, the system synthesizes the communication networks which are classified to be corresponded to the designations to then output a communication network on the basis of the designation by the user.

Further, according to the personal-connection analysis and search system in the invention, a set of constituent members (communication core) having a high communication density is extracted from the communication networks. A ratio of “communication flows between two constituent members each having a ladder-connection relationship” to “a total of communication flows” in the communication core is defined as a formal degree (a core formal degree) of the communication core.

Further, according to the personal-connection analysis and search system in the invention, a ratio of “formal communication flows” to the “a total of communication flows” between the two constituent members is defined as a formal degree (a communication formal degree) of the communications between the two constituent members. The formal communication flows are defined by a product of communication flows based on respective keywords multiplied by the formal degree of the communication core belonging to the communications. The formal communication flows in the communications which does not belong to the communication core is defined by “0”.

According to the invention, the communications based on subjects designated by user are represented by a matrix as communication networks, therefore, it is possible to analyze the communication networks, and it is also possible to present a set of constituent members and constituent members who are actively communicated with each other in relation to the designated subjects, as advantages.

Further, a formal degree of the communication core is calculated, therefore, it is possible to specify informal community in the organization.

A formal degree (path formal degree) of a search path is calculated by using the communication formal degree, therefore, it is possible to present a path corresponding to a query attribute (formal or not) by user.

Other objects, features and advantages of the invention will become apparent from the following description of the embodiments of the invention taken in conjunction with the accompanying drawings.

### BRIEF DESCRIPTION OF THE DRAWINGS

FIG. 1 is a block diagram of a personal-connection analysis and search system;

FIG. 2 is an internal constitution diagram of a personal-connection analysis and search system;

FIG. 3 is an internal constitution diagram of a terminal;

FIG. 4 is a flow chart of a personal-connection search program;

FIG. 5 is a flow chart of a communication-log data analysis program;

FIG. 6 is a flow chart of a personal-connection data generation program;

FIG. 7 is a flow chart of a keyword network core formal degree calculation;

FIG. 8 is a flow chart of a personal-connection analysis program;

FIG. 9 is a flow chart of a personal-connection search program;

FIGS. 10A and 10B are diagrams showing an example of a ladder-connection network;

FIG. 11 is a diagram showing an example of a keyword network matrix;

FIG. 12 is a diagram showing an example of a communication network matrix;

FIG. 13 is a diagram showing an example of a core formal degree matrix;

FIG. 14 is a diagram showing an example of a communication formal degree matrix;

FIGS. 15A, 15B, 15C and 15D are diagrams showing an example of matrixes used for extracting Cliques;

FIG. 16 is a diagram showing an example of a personal-connection analyzed result output screen;

FIG. 17 is a diagram showing an example of a communication core and node selection screen in the personal-connection analyzed result output;

FIG. 18 is a diagram showing an example of a personal-connection searched result output screen;

FIG. 19 is a diagram showing an example of a path selection screen in the personal-connection searched result output;

FIGS. 20A and 20B are diagrams showing an example of a ladder-connection table and node coordinate table for generating a personal-connection analyzed and searched result output screen; and

FIG. 21 is a table for explaining advantageous effects of formal degree in the personal-connection search.

### DESCRIPTION OF THE EMBODIMENTS

Hereinafter, embodiments of a personal-connection analysis and search system in the invention will be described with reference to the drawings.

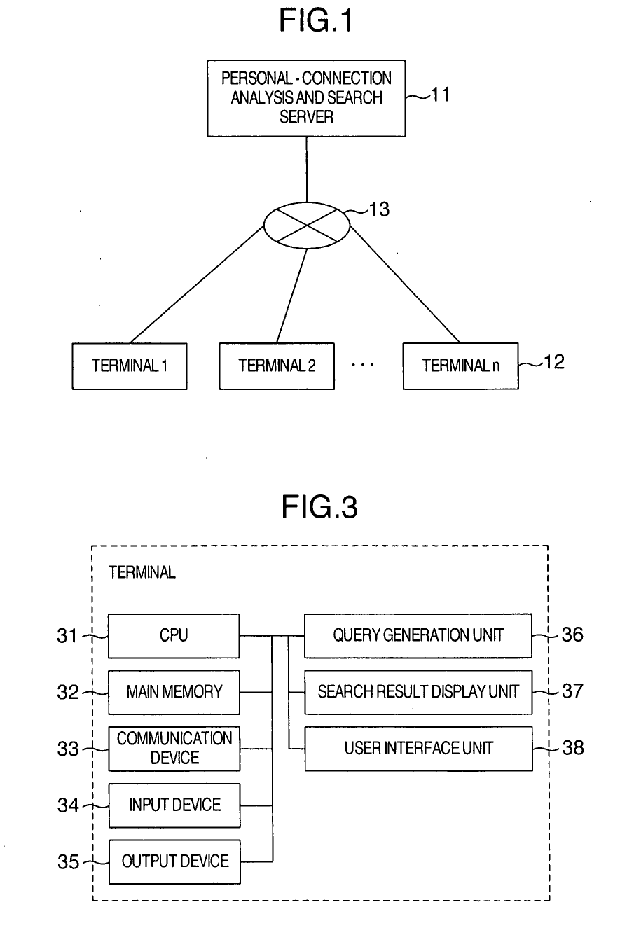

FIG. 1 is a block diagram showing a constitution of an embodiment in the invention. A personal-connection analysis and search server 11 is connected with a plurality of terminals 12 through a network 13. Each of the terminals 12 functions as a terminal to perform communications such as message exchanges by organized constituent members on an electronic mail and a weblog. Each of the terminal 12 has a user interface for performing an input and output to and from the personal-connection analysis and search server 11 of the invention. The terminal 12 is connected with the personal-connection analysis and search server 11 through the network 13.

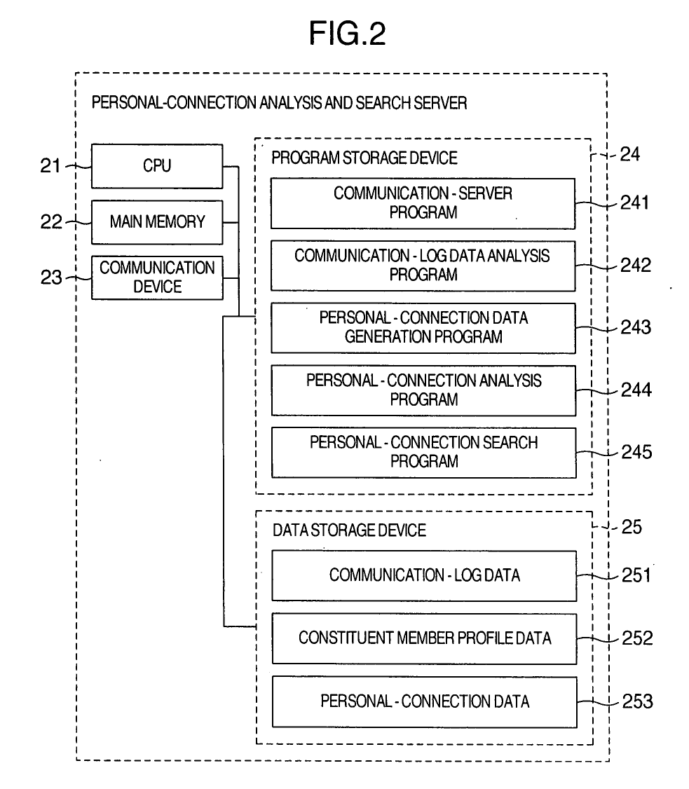

FIG. 2 is a constituent diagram of the personal-connection analysis and search server 11. The personal-connection analysis and search server 11 includes a CPU 21, a main memory 22, a communication device 23 for performing communications with the terminals through the network 13, a program storage device 24, and a data storage device 25. The program storage device 24 has a communication-server program 241, a communication-log data analysis program 242, a personal-connection data generation program 243, a personal-connection analysis program 244, and a personal-connection search program 245. These foregoing programs are executed in the CPU 21 to attain their functions. The communication-server program 241 attains functions similar to a mail server and a weblog server for realizing communications between the terminals 12. The communication-log data analysis program 242 analyzes a text in information transmitted and received by the respective constituent members to generate a constituent member profile and a keyword network. The constituent member profile contains professions of the constituent members and words representing their interests. The keyword network is a communication network defined as a communication flow representing an appearance frequency of a keyword. The personal-connection data generation program 243 performs generation of a ladder-connection network, calculation of a core formal degree of the keyword network, and calculation of a communication formal degree. The personal-connection analysis program 244 analyzes personal-connection data to output information representing a network characteristic such as a communication core and a centrality. The personal-connection data contains keyword-network data, communication formal degree data, and ladder-connection network data. The personal-connection search program 245 selects (KnowWho function) constituent members corresponding to a query (word group or natural text) designated by a user and detects a path to a constituent member selected from the constituent members (or users themselves in this case) designated by user. The data storage device 25 has communication-log data 251, constituent member profile data 252, and personal-connection data 253. The communication-log data 251 is made up of text data used in the communications between the terminals. The constituent member profile data 252 is outputted by the communication-log data analysis program 242. The personal-connection data 253 is outputted by the communication-log data analysis program 242 and personal-connection data generation program 243. Incidentally, the communication-log data may be stored in a separate device (for example, a mail server) so that the communication-log data analysis program 242 generates data by access to the separate device.

FIG. 3 is a block diagram of a terminal. The terminal is constituted by a CPU 31, a main memory 32, a communication device 33, an input device 34, an output device 35, a query generation unit 36, a search result display unit 37, and a user interface unit 38. The query generation unit 36 generates a query for implementing a personal-connection analysis and search on the basis of an input from user. The query contains information such as a keyword extracted from the input (word group or natural text) by user, an analysis and search implementation attribute such as a formal attribute, and an implementation request of the analysis or/and search. The search result display unit 37 generates a display screen to be supplied to the output device 35 on the basis of the output from the personal-connection analysis and search server 11. The user interface unit 38 provides a user interface when a user performs a personal-connection analysis and search function.

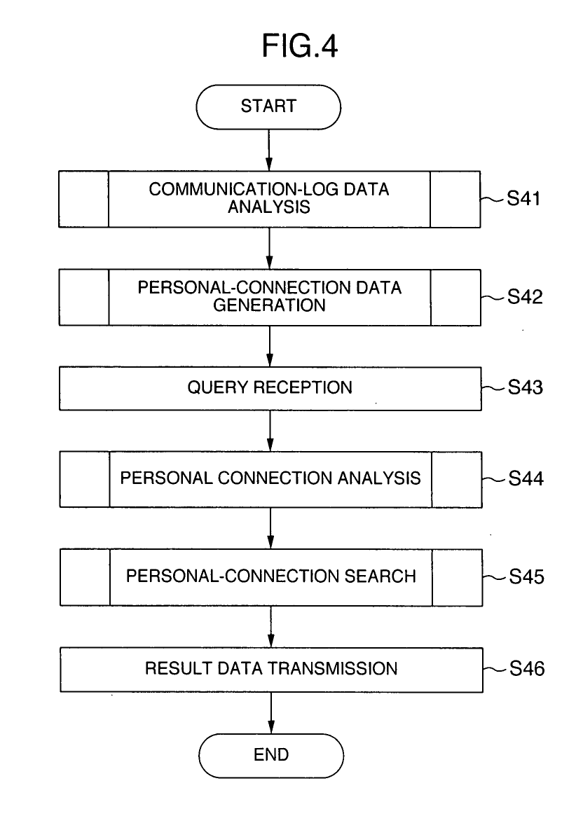

FIG. 4 is a flow chart showing a processing flow of a program group in the program storage device 24.

In step S41 of “communication-log data analysis”, information transmitted and received by respective constituted members is analyzed as a text to generate a constitute member profile and keyword network. The constituent member profile contains words and weights representing professions and interests of the constituent members, which is used for a processing of searching a knowledge possessing person for after-mentioned-personal connections. The keyword network is a communication network which is communication flows equivalent to an appearance frequency of a keyword, which will be used for after-mentioned processings of a personal-connection data generation, personal-connection analysis, and personal-connection search.

In step S42 of “personal-connection data generation”, various data generations relative to relationships between the constituent members are performed, including generation of a ladder-connection network, calculation of a core formal degree of the keyword network, calculation of a communication formal degree, etc.

In step S43 of “query reception”, a query is entered from a terminal. In step S44 of “personal-connection analysis”, the communication network synthesized the keyword network and generated on the basis of the query is analyzed so that a centrality of the communication network and a communication core are outputted. In this way, it is possible that a main person who is concerned with the communication network and a set of active constituent members in the communications are presented to the user.

In step S45 of “personal-connection search”, a constituent member who possesses the information on the basis of the query is selected (KnowWho function), and a path is outputted for use from the constituent member (or user itself in this case) designated by the user to the constituent member selected by the step S45. Therefore, it is possible that the constituent member who possesses the necessary information and the path to be directed to this constituent member are presented to the user. In step S46 of “result data transmission”, the outputs from the step S44 of “personal-connection analysis” and the step S45 of “personal-connection search” are transmitted to a terminal.

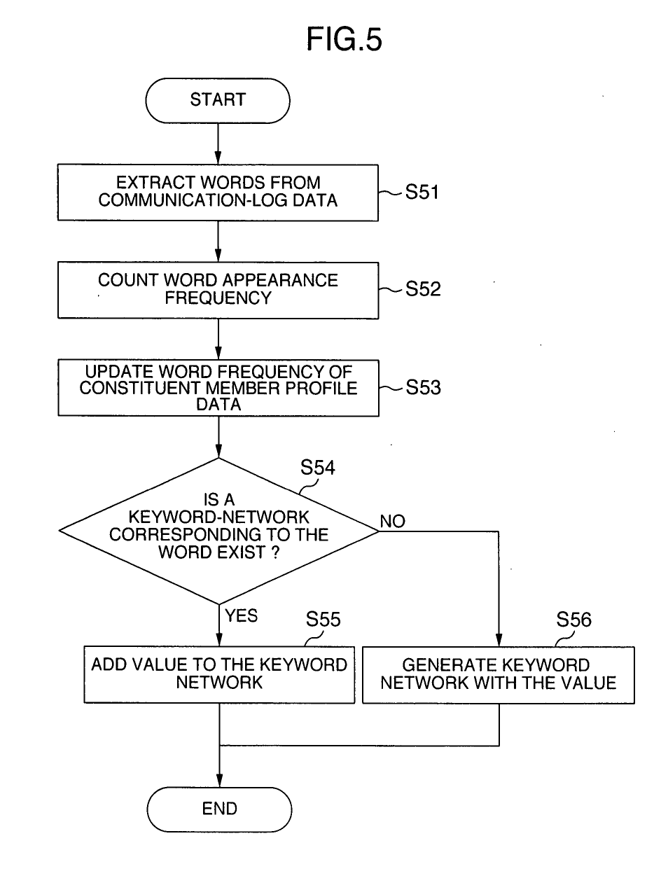

FIG. 5 is a flow chart showing a processing flow of the step S41 of “communication-log data analysis”.

In step S51, communication-log data between the constituent members is analyzed as a text, and words are extracted from the text.

In step S52 of “count word appearance frequency”, an appearance frequency is calculated from the words extracted by the step S51.

In step S53, a value of the appearance frequency calculated by the step S52 is added to the value of word appearance frequency of the constituent member profile.

In step S54, it is confirmed whether the keyword network already exists in the respective words extracted by the step S51.

In step 55, if a judged result in the step S54 is “yes”, the value of appearance frequency calculated by the step S52 is added to a value of the communication flows between the constituent members in the keyword network.

In step S56, if the judged result in the step S54 is “no”, a keyword network of the words is generated, and the value of appearance frequency calculated by the step S52 is substituted for the value of communication flows between the constituent members.

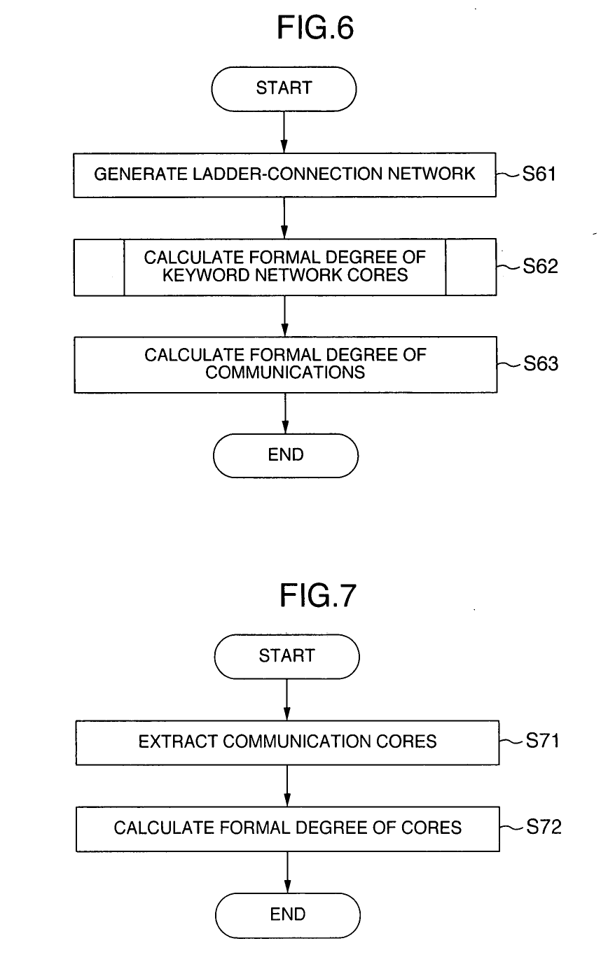

FIG. 6 is a flow chart showing a processing flow of the step S42 of “personal-connection data generation”.

In step S61 of “generate ladder-connection network”, a ladder-connection network is generated from ladder-connection information. The ladder connection information and ladder-connection network will be described in detail later.

In step S62 of “calculate formal degree of keyword-network cores”, a communication core is extracted from the keyword networks of every word generated by the step S61 to calculate a core formal degree. The extraction of communication core and the calculation of core formal degree will be described in detail later.

In step S63 of “calculate formal degree of communications”, a communication formal degree is calculated by using the core formal degree obtained by the step S62 of “calculate formal degree of keyword-network cores” in accordance with the definition by the following Expression 1. Incidentally, in the keyword networks, the core formal degree of communications which does not belong to the communication core is set by “0”.

$$\begin{matrix}communication formal degree = \frac{{\sum }_{keyword} communication flow \times core formal degree}{{\sum }_{keyword} communication flow} & ( Expression 1 )\end{matrix}$$

The communication formal degree means an index representing a formal degree of the communications between two constituent members. Using the communication formal degree, it is possible to output an appropriate path between the constituent members in response to an attribute of the personal-connection search request by user, when the personal-connection search function is realized.

FIG. 7 is a flow chart showing a processing flow of the step S62 of “calculate formal degree of keyword-network cores”.

In step S71 of “extract communication cores”, a partial network (communication cores) having communications with high density is extracted from the communication networks.

In step S72 of “calculate formal degree of cores”, a formal degree (core formal degree) of communication cores is calculated in accordance with the following Expression 2,

$$\begin{matrix}core formal degree = \frac{{\sum }_{incommunication core} \begin{matrix}communication flow between two constituent \\ members having ladder - connection relationship\end{matrix}}{{\sum }_{incommunication core} communication flow} & ( Expression 2 )\end{matrix}$$

The core formal degree is defined with the communication flows between two constitute members having a ladder-connection relationship in the communication cores, with respect to a total of the communication flows in the communication cores. The core formal degree represents a degree indicating that the communication cores are made up of communications on the basis of a formal structure in the organization. By calculating the core formal degree, it is possible to specify informal communication cores in the organization and calculate a communication formal degree between the two constituent members.

Here, in the case of extracting the communication cores by the step S71 of “extract communication cores”, various and known algorisms can be used, such as a complete graph, n-Clique, n-Clan, K-core, etc. In this embodiment, the communication cores are extracted by using the n-Clique. The clique becomes synonymous with the core, in this case.

The n-Clique is an algorism for obtaining a sub-graph capable of connecting arbitrary two nodes in a clique-in-n hop. Specifically, summation of an adjacency matrix to the nth power, in which the adjacency matrix represents presence or absence of a relationship between the two nodes, is calculated. In this way, an adjacency matrix representing whether the two constituent members can be directed with each other within n hops, is generated. With respect to the matrix, a clique is extracted by repeating exchanges of the rows and columns so that elements having a value 1 are gathered on diagonal in the matrix.

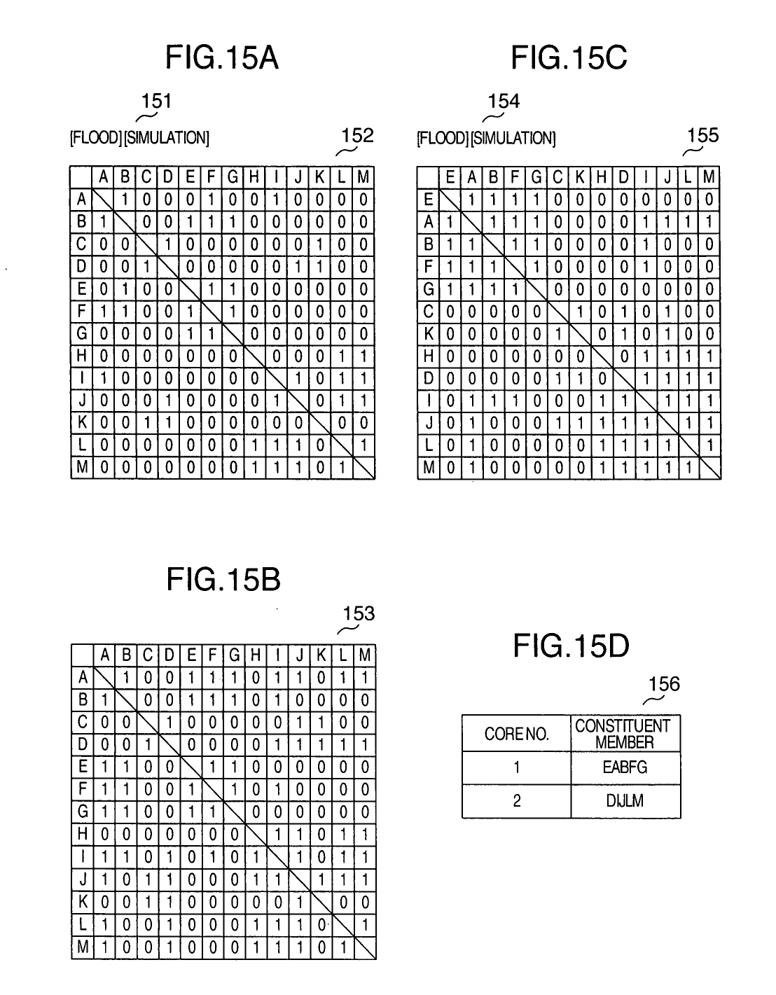

FIG. 15A shows an adjacency matrix derived from two keyword networks which are specified by “flood” and “simulation”. In the transformation from the keyword network to the adjacency matrix, the respective elements in the adjacency matrix are set to “0” or “1” by comparing the communication flows between the two constituent member represented by the matrix elements of the keyword network with a predetermined threshold value, with a comparison determined by a large or small manner in this case. In the case of synthesizing (AND) plural adjacency matrixes, a logical product of values on the same element positions between the adjacency matrixes becomes a value of the elements in the synthesized adjacency matrix. In the case where the adjacency matrix in FIG. 15A is an input and an n-Clique extraction is implemented as n=2, an adjacency matrix representing constituent members who can be directed to each other by two hops becomes shown by FIG. 15B. With respect to FIG. 15B, a communication core matrix which is a result of implementing the exchanges of the rows and columns is shown in FIG. 15C. By the calculation of these clique extractions, two communication cores are output as shown in FIG. 15D.

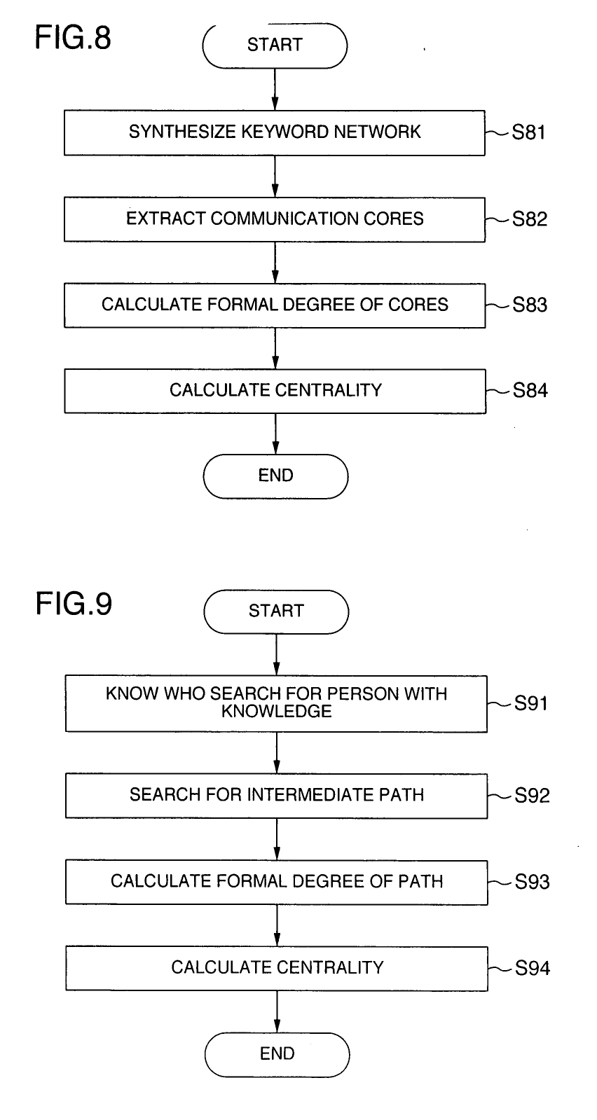

FIG. 8 is a flow chart showing a processing flow of the personal-connection analysis program 244.

In step S81 of “synthesize keyword-network”, the keyword network for respective words, which is contained in the query received by the step S43 of “query reception”, is added to one another to generate a communication network on the basis of the designation by the user.

In step S82 of “extract communication cores” and in step S83 of “calculate formal degree of the cores”, identical processings to the step S71 of “extract communication cores” and the step S72 of “calculate formal degree of cores” are implemented by using the communication network, as an input, generated in the step S81 of “synthesize keyword-network”.

In step S84 of “calculate centrality”, a centrality for respective constituent members is calculated in the communication network generated by the step S81. The centrality means a value indicating whether each of the nodes has how many connections are concerned with other nodes in a network and how many the other nodes are intermediately transmitted through the network. In the case of the invention, a degree indicating how the respective constituent members are contributed to communications is represented by the centrality in the communication network on the basis of the keyword entered by user. By outputting the centrality, the user can discriminate main constituent members in the communication network. The centrality can be calculated by a known algorism disclosed in “Basis of Social Network Analysis” by Jun Kanamitsu, Keisou Publishing Inc., Chart 6 “Centrality”, Dec. 20, 2003, Vol. 1, Version 1. (non-patent document 1)

FIG. 9 is a flow chart showing a processing flow (step S45) of the personal-connection search program 245.

In step S91 of “know-who search for person with knowledge”, the constituent member profile generated by the step S41 of “communication-log data analysis” is searched by using the query received by the step S43 of “query reception”, so that a constituent member to be presumed to possess necessary knowledge with high probability is detected by user.

In step S92 of “search for intermediate path”, a path is detected as a connected path through constituent members other than the two constituent members, between the constituent member (or user itself in this case) designated by user and the knowledge possessing constituent member detected by the step S91. The search for intermediate path uses either the communication network generated by the step S81 of “synthesize keyword-network” or the communication network synthesized over the total of keywords in the keyword network. There is Warshall-Floyd method or the like to search a path for connecting between two designated constituent members by the shortest distance.

In step S93 of “calculate formal degree of the path”, a formal degree of the path detected by the step S92 is calculated in accordance with the following Expression 3.

$$path formal degree = \frac{{\sum }_{in path} communication formal degree}{number of path hops} \qquad ( Expression 3 )$$

The path formal degree is defined with an average value of the communication formal degrees in the paths. By outputting the path formal degree, the user can select an optimal path for the knowledge possessing person in response to a background which needs knowledge.

In step S94 of “calculate centrality”, a centrality is calculated in the communication network used by the step S92 of “search for intermediate path”.

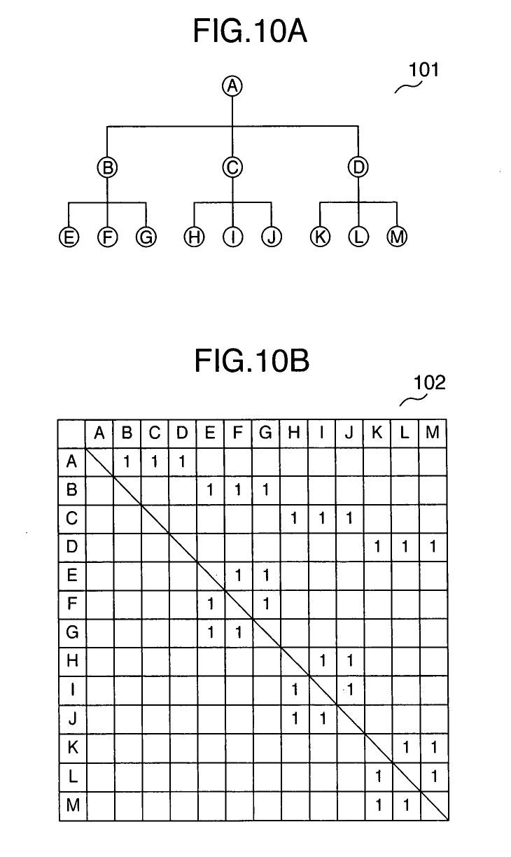

In this embodiment, a plurality of feature quantity sets of relationship between the two constituent members are used such as the communication network. As a method of holding these values, there is a method of using a matrix representation. A matrix representing a social relationship between the constituent members is particularly referred to as a sociomatrix. Matrix representations of the respective networks and feature quantities will be described with reference to FIG. 10 to FIG. 15.

FIGS. 10A and 10B show a ladder connection network matrix. A three-hierarchical ladder-connection indicated by 101 (FIG. 10A) is shown as a matrix representation by 102 (FIG. 10B). A value of element is set to “1” when a ladder-connection relationship exists. The ladder-connection relationship has directivity, which is determined by the following rule. That is, two arbitrary constituent members belonging to the same leader have a ladder-connection relationship in a bi-direction, which is a case where the two constituent members belong to the same department or section, for example. The relationship between the leader and constituent members who belong to the leader has a ladder-connection in one-way directed to the constituent members from the leader. The ladder-connection relationship of designated number of hops is traced to the matrix 102 to implement calculation for providing a ladder-connection relationship between the two arbitrary constituent members to be able to generate a path, so that it is possible that a more extended meaning of ladder-connection network matrix is generated.

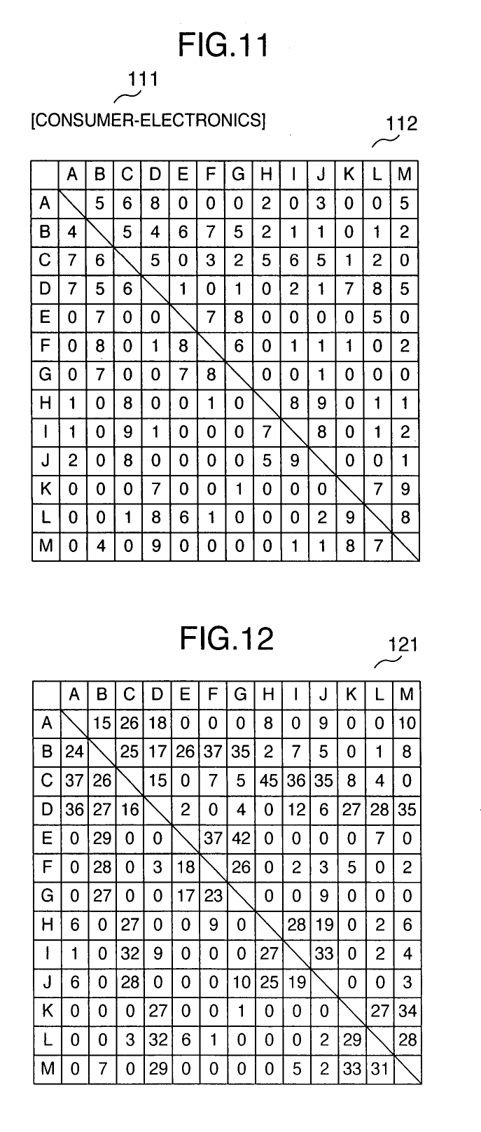

FIG. 11 shows a keyword network matrix to be generated at every keyword. A reference numeral 111 is a label representing a keyword. In FIG. 11, keyword networks based on communications relative to a keyword “consumer-electronics” are illustrated by an example. A numeral 112 is a keyword network matrix indicating values equivalent to communication flows on the basis of an appearance frequency of the keyword. The keyword network matrix has directivity, and has values of elements equivalent to communication flows from constituent members represented by row symbols (A, B, C . . . , M) to constituent members represented by column symbols (A, B, C . . . , M). According to the keyword network matrix, the condition of communications in the organization can be represented with a keyword specialized. Further, plural keyword network matrixes are synthesized so that the condition of the communications in the organization can be represented on the basis of contents specified by a keyword group. The calculation is implemented for these communication network matrixes so that it is possible to make the feature of communication networks into the quantization.

FIG. 12 shows a communication network matrix. A communication network matrix 121 is a matrix representing values of elements equivalent to the communication flows, which is obtained from synthesizing the foregoing plural keyword network matrixes. The communication network matrix has directivity, and has values of elements equivalent to the communication flows from the constituent members represented by the row symbols (A, B, C . . . , M) to the constituent members represented by the column symbols (A, B, C . . . , M). According to the communication network matrix, the condition of communications can be represented on the basis of contents specified by a keyword group. The calculation is implemented for these communication network matrixes so that it is possible to make the feature of communication networks into the quantization.

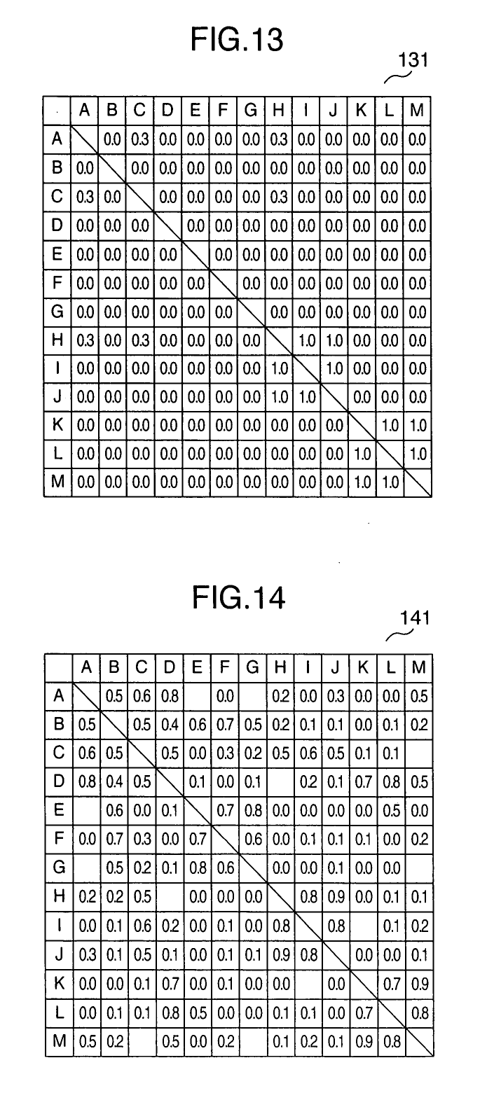

FIG. 13 shows a core formal degree matrix. A core formal degree matrix 131 is a matrix indicating values of a core formal degree of the communication cores extracted from either the keyword networks or communication networks. Respective elements have values of the core formal degree of the communication cores belonging to the communications between the two constituent members represented by the row and column labels. Incidentally, the value of element is set to “0” when the communications between two constituent members do not belong to the communication cores.

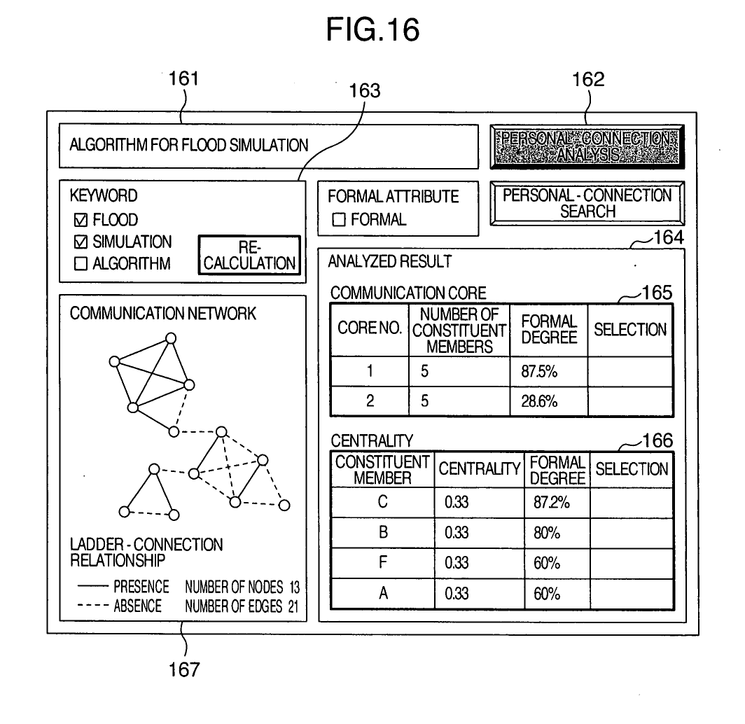

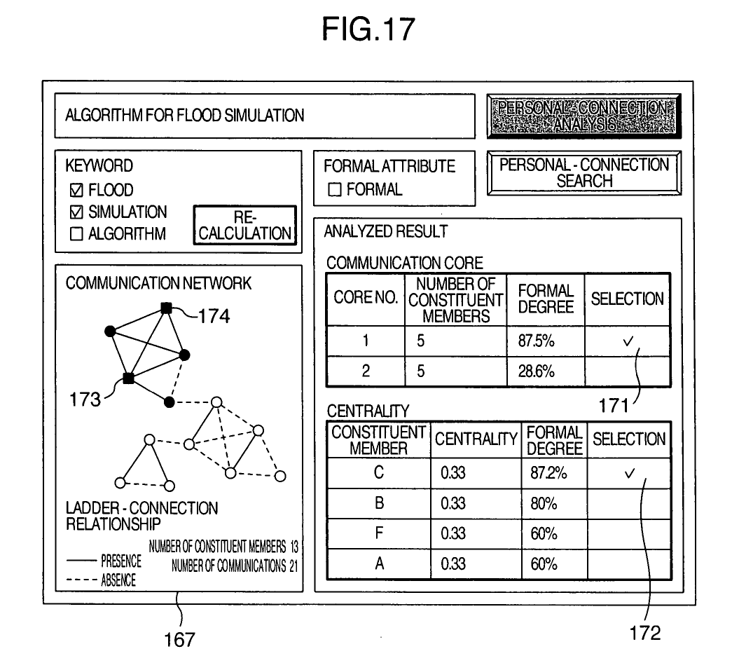

FIG. 16 shows an example of a personal-connection analysis output screen. A reference numeral 161 denotes a query input unit of user. The query is entered with words and natural text. In the case of entering the natural text, the text is divided into words by using the morphological analysis method as a know method and can be made into a keyword train of the query. A numeral 162 denotes a personal-connection analysis implementation command button. The button 162 is clicked after the query is entered. The query is then transmitted to the personal-connection analysis and search server 11 from the terminal 12, and a personal-connection analysis is implemented on the basis of the query in the server 11. A numeral 163 denotes a display of the keyword extracted from the query. Incidentally, in the case where a keyword is designated again, the query is transmitted to the personal-connection analysis and search server 11 from the terminal 12, and a personal-connection analysis is again implemented on the basis of the query in the server 11. A numeral 164 denotes a display of the analyzed result. The analyzed result 164 contains a communication core extracted result 165 and a centrality calculated result 166. The communication core extracted result 165 is generated by the communication cores (FIG. 15B) as an output by the step of “extract communication cores” and the core formal degree matrix (FIG. 13) which is an output by the step S83 of “calculate formal degree of cores”. In the communication core extracted result 165, the user can designate an arbitrary communication core, and a node is displayed emphatically in the designated communication core. A centrality calculated result 166 is generated from the output by the step S84 of “calculate centrality”. In the centrality calculated result 166, the user can designate arbitrary constituent members, and a node representing the designated constituent members is displayed emphatically. An example of a screen display is shown in FIG. 17 as an emphasized display.

The core formal degrees as important indexes are displayed every core in the communication core extracted result 165 and centrality calculated result 166.

A reference numeral 167 denotes a display of the communication networks based on the keyword extracted from the query. In the display 167, the presence and absence of the ladder-connection relationship are dividedly displayed by solid lines (a ladder-connection is present) and dotted lines (a ladder-connection is absent).

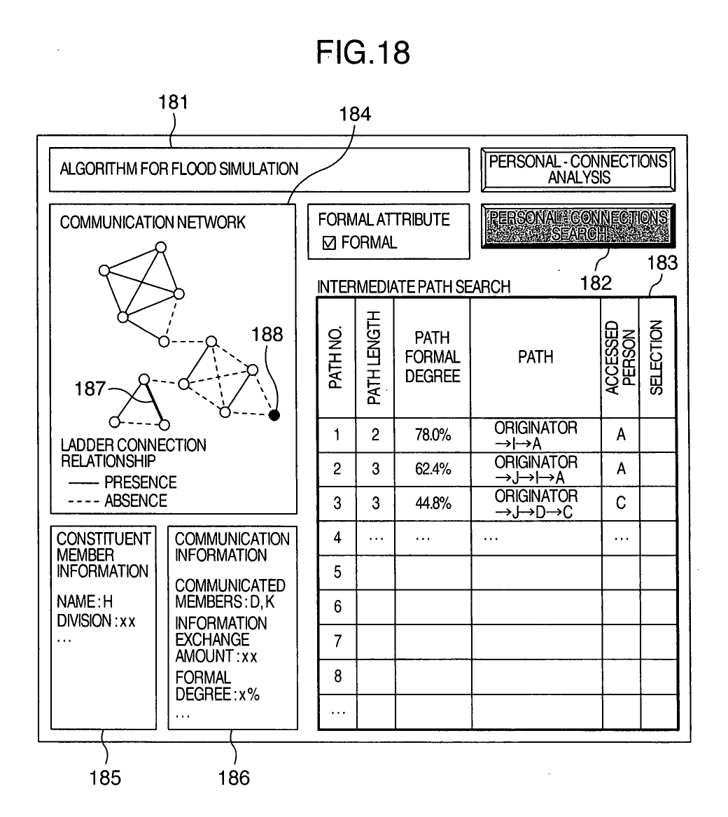

FIG. 18 shows an example of a personal-connection search result output screen. A reference numeral 181 is the same as the foregoing query input portion 161. A numeral 182 denotes a personal-connection search implementation command button. The button 182 is clicked after the query is entered, the query is then transmitted to the personal-connection analysis and search server 11 from the terminal 12, and a personal-connection search is implemented on the basis of the query in the server 11. A numeral 183 denotes a display of a path searched result. The path searched result is generated from the outputs by the step S92 of “search for intermediate path” and the step S93 of “calculate formal degree of the path”. The user can designate an arbitrary path from the path searched result 183, and the designated path is displayed emphatically. Path formal degrees as important indexes are displayed every path in the path searched result 183. A numeral 184 denotes communication network. In the communication network 184, the presence and absence of ladder-connection relationship are dividedly displayed by solid and dotted lines, as the same as described in FIG. 16. The user can designate arbitrary constituent members and communications between the constituent members from the communication networks 184. Nodes representing the designated constituent members and edges representing communications between the constituent members are displayed emphatically. A numeral 185 denotes a display of detailed information for the constituent members designated by user. A numeral 187 denotes a display of detailed information of the edges designated by user.

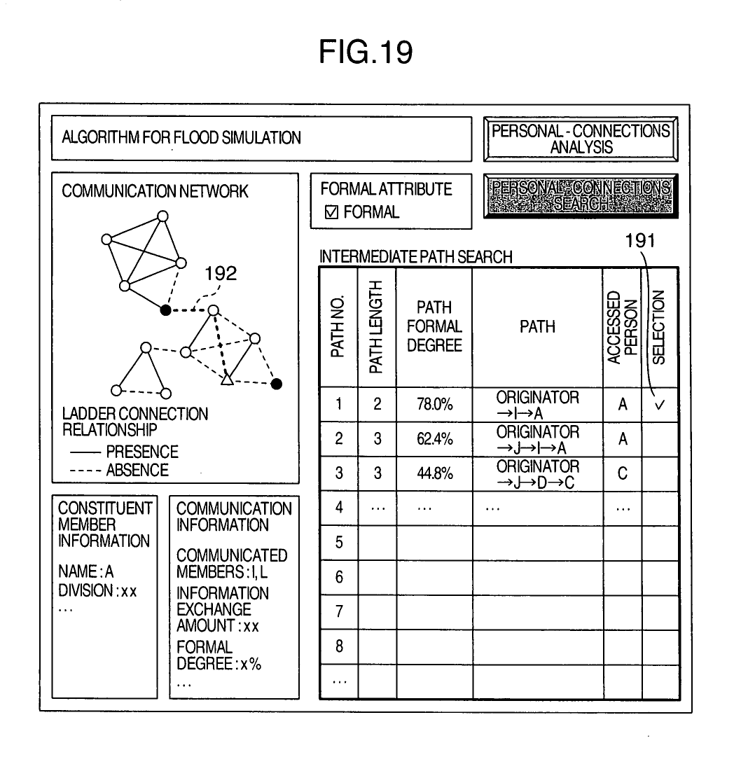

Further, when the user designates a path, the designated path is displayed emphatically by a width of edges, and a knowledge possessing person is displayed emphatically by a color of node. An example of an emphatically displayed screen is shown in FIG. 19.

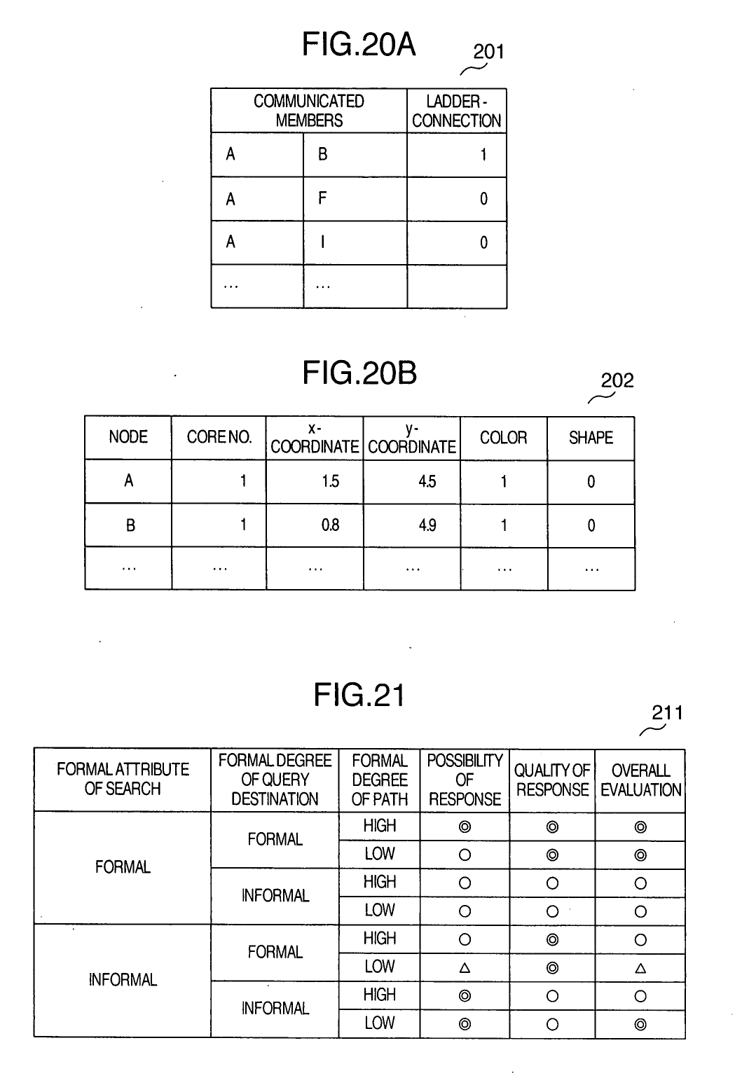

The displays for the communication networks in FIG. 16, FIG. 17, FIG. 18, and FIG. 19 is implemented by using tables for storing output information shown in FIGS. 20A and 20B. The table in FIG. 20A is a set of row label and column label containing the values of elements in the ladder-connection network matrix of FIG. 10B. The table in FIG. 20B is constituted by core Nos. (FIG. 15D) of the communication cores concerned with the respective constituent members and x-y coordinates calculated so as to be arranged visually and appropriately with use of such as a spring model. Incidentally, “0” is set to the core No. of the node which does not belong to the cores.

Generally, according to a formal attribute indicating whether a condition of requesting information by a user is officially or privately, if knowledge possessing constituent members are selected appropriately in such a way that it is decided that a query is easily reported to the knowledge possessing constituent members from the user and easily obtained a response from the members, more effective information collection and formation for the personal-connections can be implemented. A response evaluation index (⊚: good, ◯: fair, Δ: no good) for a combination of formal attributes and path formal degrees is shown in FIG. 21.

For example, in the case where a user sends the knowledge possessing constituent members a formal query relevant to a business operation, a good response can be expected to receive from the members if the user queries the members or query destination members by using a query destination (core) formal degree, the query destination having a high formal degree with a path formal degree, and a query path (personal connection).

On the contrary, in the case where a query of the user is low relevancy to his/her business operation or privately informal for him/her, a good response can also be expected to receive from the members if the user queries the members by using a path of the foregoing formal query destination and the query destination having a low formal degree rather than the path.

If the foregoing control is designated by the user with the formal attribute to request information, it is possible to realize automation.

Therefore, the invention is applicable to a person and personal-connection search system such as KnowWho system, and an organization management support system for support to make an organization activated.

It should be further understood by those skilled in the art that although the foregoing description has been made on embodiments of the invention, the invention is not limited thereto and various changes and modifications may be made without departing from the spirit of the invention and the scope of the appended claims.

1. A personal-connection analysis and search sever connected with a plurality of terminals through a network, comprising:
a communication-log data storage unit that stores log data of an electronic communication implemented by using the plurality of terminals in an organization; and
a personal-connection network analysis unit that generates a keyword network, for every word, representing a relationship between constituent members in the organization communicated by using the word extracted from the log data stored in the communication-log data storage unit; generates a communication network synthesized over plural words, each of which corresponds to the generated keyword network; extracts a communication core as a set of the constituent members who have large communication flows with each other, with respect to a combination of specific words or words, from the generated communication network and the keyword network; and calculates a core formal degree representing an organization consistence degree of the communication core by using the communication core and ladder-connection information representing a relationship, as an official organization, between the constituent members in the organization.

2. The server according to claim 1, further comprising a personal-connection data generation unit that calculates a communication formal degree as a formal degree of a relationship between the two constituent members from the core formal degree, the keyword network and the communication network, when two constituent members belong to the communication core of any of the words.

3. The server according to claim 2, as to two constituent members input, wherein a group of constituent members each having a communication history is searched for a relationship between the two constituent members from the log data of the communication and relationships are combined with each other; a path is detected as an indirect connection between the two constituent members through a different constituent member; the communication formal degree between the respective constituent members included in the path is added to calculate a path formal degree obtained from an added value divided by number of paths.

4. The server according to claim 1, wherein the communication core and its core formal degree thereof for combination of specific words or words input are outputted.

5. The server according to claim 2, wherein the communication formal degree calculated for the two constituent members input is outputted.

6. The server according to claim 2, wherein a path and its path formal degree calculated for the two constituent members input are outputted.

7. A personal-connection analysis and search program that is computer readable and executable in a personal-connection analysis and search server connected with a plurality of terminals through a network, enabling an arithmetic unit in the personal-connection analysis and search server to execute the steps of:
a first step of reading out log data of an electronic communication implemented by using the plurality of terminals in an organization, from a storage unit of the personal-connection analysis and search server or an accessible storage unit through the network;
a second step of generating a keyword network, for every word, representing a relationship between constituent members in the organization communicated by using the word extracted from the log data;
a third step of generating a communication network synthesized over plural words, each of which corresponds to the generated keyword network; and
a fourth step of extracting a communication core having large communication flows, with respect to a combination of specific words or words, from the generated communication network and the keyword network, and calculating a core formal degree representing an organization consistence degree of the communication core by using the communication core and ladder-connection information representing a relationship, as an official organization, between the constituent members in the organization.

8. The program according to claim 7, enabling the arithmetic unit in the personal-connection analysis and search server to execute a fifth step of calculating a communication formal degree, as a formal degree of a relationship between two constituent members from the core formal degree, the keyword network and communication network.

9. The program according to claim 7, enabling the arithmetic unit of the personal-connection analysis and search server to execute the steps of:
a sixth step of searching, as to two constituent members input, a group of constituent members each having a communication history for a relationship between the two constituent members from the log data of the communication, combining relationships with each other, and detecting a path as an indirect connection between the two constituent members through a different constituent member; and
a seventh step of adding the communication formal degree between the respective constituent members included in the path to calculate a path formal degree obtained from an added value divided by number of paths.

10. The program according to claim 7, enabling the arithmetic unit in the personal-connection analysis and search server to execute a eighth step of outputting the communication core and its core formal degree thereof for combination of specific words or words input.

11. The program according to claim 8, enabling the arithmetic unit in the personal-connection analysis and search server to execute a ninth step of outputting the communication formal degree calculated for the two constituent members input.

12. The program according to claim 9, enabling the arithmetic unit in the personal-connection analysis and search server to execute a tenth step of outputting a path and its path formal degree calculated for the two constituent members input.
